(19) United States
(12) Patent Application Publication
(10) Pub. No.: US 2016/0354713 A1
(43) Pub. Date: Dec. 8, 2016

(54) Filter Element and Filter System with Partial-Flow Filtering

(71) Applicant: MANN+HUMMEL GMBH, Ludwigsburg (DE)

(72) Inventors: Marco Schweikart, Marbach (DE); Martin Weindorf, Kornwestheim (DE); Tiago Felipe Oliveira da Silva, Ehningen (DE)

(21) Appl. No.: 15/168,087

(22) Filed: May 29, 2016

Related U.S. Application Data
(63) Continuation of application No. PCT/EP2014/074211, filed on Nov. 10, 2014.

(30) Foreign Application Priority Data
Nov. 28, 2013 (DE) 102013019887.9

(51) Int. Cl. B01D 29/54; B01D 35/00; B01D 29/15

(52) U.S. Cl. CPC B01D 29/54; B01D 29/15; B01D 35/005; B01D 2201/34; B01D 2201/32

(57) ABSTRACT

A filter element (10) has at least a first filter body (12) that is separated in a fluid-tight fashion from a second filter body (14) and is arranged above the second filter body (14) in an axial direction (L). A first flow outlet (24) proceeds from the first filter body (12) and a second flow outlet (26), proceeding from the second filter body (14), is arranged outside the first flow outlet (24) in a transverse direction (Q) perpendicular to the axial direction (L). A centering element (20) that acts in the transverse direction (Q) is arranged on an end disc (16) of an end face (15) of the filter element and corresponds to a corresponding receptacle (110) of a filter housing (108).

### TECHNICAL FIELD

The invention relates to a filter element with partial-flow filtering, especially for use as an oil filter for an internal combustion engine, and to a filter system for using such a filter element.

### BACKGROUND

Oil filter systems are known in which a ring filter element acts as the main flow filter, while a centrifuge works as a partial flow filter. Partial flow filtered by the centrifuge then flows on the clean side through an outlet in the filter housing into a collection container, preferably into the oil pan of the internal combustion engine fitted with the device. While the main flow filter filters the lubricating oil required for proper operation of the internal combustion engine relatively coarsely, a relatively fine filtering effect may be attained using the partial flow centrifuge.

Known from DE 102 46 151 A1 is a filter system that works with a ring filter element. When the ring filter element is inserted into the housing, a journal that protrudes upon placement penetrates into an idle channel that is embodied in the bottom of the filter housing. When the ring filter element is placed, the idle channel is tightly sealed by the journal inserted therein. A discharge channel is integrated into the journal and, when a filter fitted with the ring filter element is operating, fluid travels e.g. from the clean side of the ring filter element into the channel into which the journal is inserted. In this manner it is possible to intentionally drain fluid into the channel that in conventional ring filter elements is closed by the journal. Using the idle channel, the fluid remaining in the filter element can flow out of the filter housing when the filter element is removed, for instance when the filter element is exchanged, so that no fluid travels into the environment.

DE 102 46 151 A1 furthermore describes an embodiment in which the ring filter element is embodied as a partial flow filter or includes a partial or secondary flow filter. The discharge channel is then dimensioned, with respect to its flow resistance, such that a partial flow flowing through the partial flow filter is limited to a prespecified volume flow or is limited to a prespecified portion of a total flow formed from the partial or secondary flow and a main flow. Using this deliberate dimensioning of the discharge channel, the latter then fulfills an additional function in that not only does it permit the draining of a partial or secondary flow, but it also limits the volume flow thereof.

Known from DE 10 201 2 022 244 A1 is a filter module having a main flow filter element and a partial flow filter element that are each equipped with a supporting tube. The supporting tubes are embodied such that the two filter elements may be coupled to one another lying axially above one another via the supporting tube. Such a filter module is relative complex to manufacture.

### SUMMARY

One object of the invention is therefore to create a filter element that has a compact and cost-effective design for a partial flow operation.

Another object of the invention is to create a filter system for using a filter element that has a compact and cost-effective design for a partial flow operation

In accordance with one aspect of the invention, the aforesaid objects are attained by a filter element that includes at least a first filter body that is separated in fluid-tight fashion from a second filter body and is securely connected to the second filter body via at least one end disc, and that is arranged above the second filter body in an axial direction, wherein a first flow outlet proceeds from the first filter body and a second flow outlet, proceeding from the second filter body, is arranged outside the first flow outlet in a transverse direction perpendicular to the axial direction, wherein a centering element that acts in the transverse direction is arranged on an end disc of an end face of the filter element and corresponds to a corresponding receptacle of a filter housing.

Advantageous embodiments and advantages of the invention result from the other claims, the description, and the drawings.

A filter element is suggested that includes at least a first filter body that is connected to a second filter body via at least one end disc and that is separated from the second filter body in a fluid-tight fashion and that is arranged above the second filter body in an axial direction, wherein a first flow outlet proceeds from the first filter body and a second flow outlet, proceeding from the second filter body, is arranged outside the first flow outlet in a transverse direction perpendicular to the axial direction. The first filter body and the second filter body are securely connected to one another via the at least one end disc and form a non-separable unit. This permits a very compact structure of the filter element. Both filter bodies are preferably embodied as media bellows enclosed between end discs, wherein the filter bodies are each securely connected at one end face to a common end disc, especially welded thereto. Thus, compared to an arrangement, likewise possible, made of two separate filter bodies, each enclosed between two end discs, one end disc is saved, which not only reduces costs, but also saves space. Furthermore, a centering element that acts in the transverse direction is arranged on an end disc of an end face of the filter element and corresponds to a corresponding receptacle of a filter housing. In particular the second flow outlet can surround the first flow outlet.

The suggested filter element comprises a main flow filter, the first filter body, and a partial flow filter, the second filter body, which are arranged above one another in the axial direction. The fluid flow, for instance oil in the case of an oil filter for an internal combustion engine, of the clean side of the partial flow filter is thus returned to the oil sump. In the same manner, promoted by the standing design of the filter element, the oil is returned to the oil sump during service when the filter element is exchanged. In order to ensure proper flow through the main and partial flow filter bodies, it is advantageous to design the pressure differences from the raw side to the clean side of the main flow and partial flow filters for the different fineness of the filter favorably, which means that the cross-section of the opening of the flow outlet to the oil sump on the partial flow filter side should be designed appropriately. The main flow filter is designed for relatively coarse filtering, while the partial flow filter is designed for very fine filtering. Typical values are for instance a through-flow of about 150 L/min on the main flow filter side to a flow of about 7 L/min on the partial flow filter side. Other flow values may also be provided, depending on the size and purpose of the filter element.

The advantage of the inventive solution is found in high integratability of the filter system and in corresponding material and cost savings. Since centrifuges are frequently used for operating the partial flow in conventional filter systems, the savings are particularly high because it replaces a solution with a centrifuge. Due to the integral embodiment of the filter element, no additional mechanical connecting means for connecting the two filter bodies are needed, so that the suggested filter element can be produced cost-effectively, in addition to being compact in size.

Advantageously, the second flow outlet may be arranged inside the centering element. In this way the second flow outlet is effectively integrated without additional lines into the filter element. In addition, this means that the functions of centering the filter element during installation into the filter system and guiding the second flow outlet into the appropriate outlet out of the filter system are combined.

In one advantageous embodiment, the transverse direction may include a direction radially perpendicular to the axial direction. This is the case if the centering element and thus the second flow outlet are arranged radially outside of the first flow outlet, for instance in an annular arrangement, so that the filter element is thereby embodied radially symmetrical and does not have any preferred direction during installation into the filter housing, which is advantageous for assembly when the filter element is exchanged.

Advantageously, the centering element may be formed by two tube segments nested inside one another. In this manner the second flow outlet may be advantageously added and integrated between the two tube segments and the entire arrangement is advantageously designed radially symmetrical for assembly.

Advantageously, walls of the two tube segments may be connected to one another via supports. Because of this, the two tube segments may be appropriately reinforced, which is particularly advantageous for the embodiment as a centering element on which forces may certainly act during the assembly of the filter element in the filter housing and, with vibrations, when the filter system is operating. A flow guide for the outflowing fluid may also be appropriately influenced, for instance restricted, by the supports.

In one advantageous embodiment, the centering element may also include a radially double-concentric sealing element to the filter housing. This represents additional integration of functional elements into the filter element. Using the double-concentric sealing element, the orientation and guiding of the filter element in the filter housing as well as the necessary sealing element are integrated in one functional element, which then has an advantageous effect on the assembly of the filter element and the reliability of the filter system.

The double-concentric sealing element may advantageously include at least one seal arranged radially exteriorly and one seal arranged radially inwardly. Using the double sealing element on the inside of the centering element as well as on the outside ensures that the clean side of the filter system is reliably separated from the raw side and that furthermore the first flow outlet of the main flow filter body is reliably separated from the second flow outlet of the partial flow filter body. The two seals may be molded onto the walls of the tube segments, or they may be formed from O-rings.

Advantageously, at least one restriction may be arranged in the second flow outlet. To set the pressure conditions favorably and to select the filter effect of the main and partial flow filter suitably, it is advantageous to install a restrictor in the second flow outlet of the partial-flow filtering and to thus reduce the flow speed of the filtered fluid, since the partial-flow filtering represents the fine filtering. Typically, when using the invention as an oil filter for an internal combustion engine, an opening of 2-2.5 mm is adequate to ensure a flow of 7 L/min.

It may be advantageous when the second flow outlet forms or has a restriction. In this manner no additional element is necessary to provide a restrictor that would also have to be attached. The restriction is advantageously added in the form of at least one opening, preferably two openings, in the centering element or end disc on which the centering element is arranged.

The advantage when incorporating a restriction in the second flow outlet or in embodying the second flow outlet as a restriction is that since the restriction is arranged in the filter element, when the filter element is removed the complete cross-sectional area of the receptacle for the second flow outlet is available for the fluid to drain.

In accordance with another aspect, the invention relates to a filter system that includes a filter housing, an inlet arranged on the filter housing for supplying a fluid to be filtered, especially oil, first and second outlets arranged on the filter housing for draining the filtered fluid, and at least one exchangeable filter element that is arranged between the inlet and the two outlets and separates a raw side of the filter system from a clean side of the filter system, and which includes at least a first filter body that is separated in a fluid-tight fashion from a second filter body and that is arranged above the second filter body in an axial direction and is securely connected thereto via an end disc. A first flow outlet proceeds from the first filter body and opens into a first outlet, wherein a second flow outlet, proceeding from the second filter body, is arranged outside the first flow outlet in a transverse direction perpendicular to the axial direction and opens into the second outlet. Furthermore, a centering element that acts in the transverse direction is arranged on an end disc of an end face of the filter element and corresponds to a corresponding receptacle of a filter housing. Such a filter system ensures effective filtering of a fluid in main flow and partial flow filter operation with simultaneously the most compact and cost-effect design possible.

In one advantageous embodiment, the transverse direction may include a direction radially perpendicular to the axial direction. This is the case when the centering element of the filter element, and thus the second flow outlet, are arranged radially outside the first flow outlet, for instance in an annular arrangement, so that the filter element is embodied radially symmetrical and does not have a preferred direction during installation into the filter housing, which is advantageous for assembly when the filter element is exchanged.

The second filter body may advantageously be embodied as a partial flow filter and thus manage without the use of centrifuges, which are very commonly used in the prior art.

In one advantageous embodiment, the described filter system may be used as an oil filter, especially an oil filter for an internal combustion engine.

### BRIEF DESCRIPTION OF THE DRAWINGS

Additional advantages result from the following description of the drawings. Exemplary embodiments of the invention are depicted in the drawings. The drawings, the description, and the claims contain numerous features in combination. The person skilled in the art will usefully also consider the features individually and combine them to make reasonable additional combinations.

The following figures are provided as examples.

FIG. 1 is a perspective elevation of a filter element in accordance with one exemplary embodiment of the invention;

FIG. 2 is a perspective elevation of a filter element, focusing on a centering element in accordance with one exemplary embodiment of the invention;

FIG. 3 is a longitudinal section of a filter system in accordance with one exemplary embodiment of the invention;

FIG. 4 is a view of detail of the longitudinal section in FIG. 3, focusing on the centering element; and,

FIG. 5 is an exterior view of a filter system in accordance with one exemplary embodiment of the invention.

### DETAILED DESCRIPTION

In the figures, identical or similar components have the same reference numbers. The figures are merely examples and shall not be construed to be limiting.

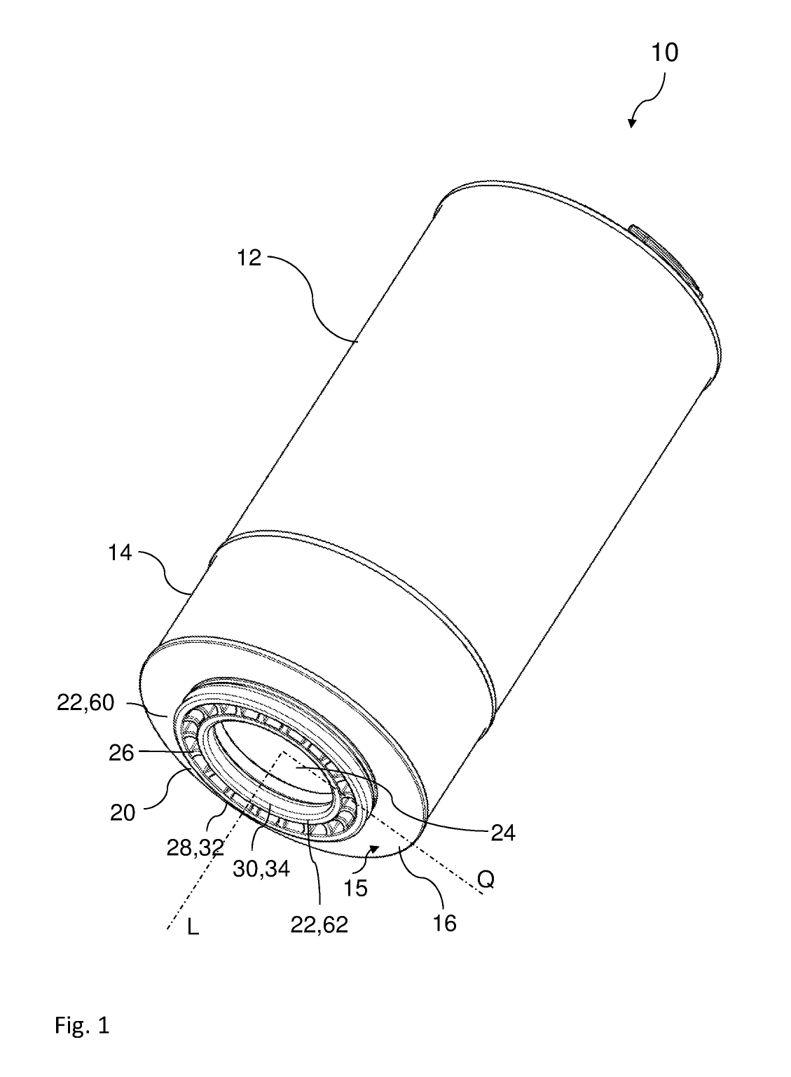

FIG. 1 is a perspective elevation of a filter element 10 in accordance with one exemplary embodiment of the invention. The filter element 10 comprises a first filter body 12 that is embodied as a hollow cylinder and that is separated in a fluid-tight fashion from a second filter body 14 and that furthermore is arranged above the second filter body 14 in an axial direction L. The second filter body 14 is also embodied as a hollow cylinder. The two filter bodies 12, 14 are securely connected to one another via a common end disc. Proceeding from the first filter body 12 is a first flow outlet 24 that is embodied centrally in the interior of the hollow cylinder. A second flow outlet 26 proceeding from the second filter body 14 is arranged outside of the first flow outlet 24 in a transverse direction Q perpendicular to the axial direction L. A centering element 20 acting in the transverse direction Q is arranged on an end disc 16 of an end face 15 of the filter element and corresponds to a corresponding receptacle 110 of a filter housing 108.

The second flow outlet 26 is arranged inside the centering element 20. In the embodiment depicted in FIG. 1, the transverse direction Q includes a direction radially perpendicular to the axial direction L, so that the centering element 20 and the second flow outlet 26 are embodied in a radially symmetrical arrangement annularly about the longitudinal axis L. The centering element 20 is formed by two tube segments 28, 30 nested inside one another, wherein the walls 32, 34 of the two tube segments 28, 30 are connected to one another by supports 36. The supports 36 are distributed uniformly around the circumference of the centering element 20. The centering element 20 furthermore includes a radially double concentric sealing element 22 to the filter housing 108. The double-concentric sealing element 22 includes a seal 60 arranged radially exteriorly and a seal 62 arranged radially inwardly. The seals 60, 62 are molded onto the tube segments 28, 30.

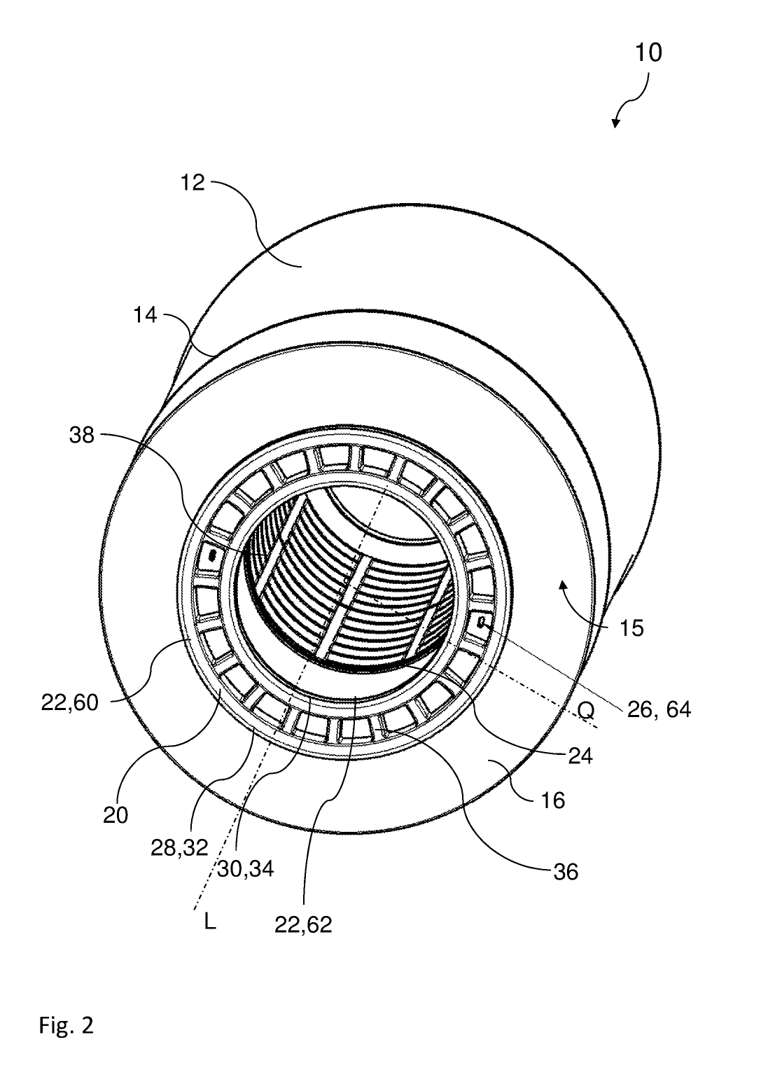

FIG. 2 is a perspective elevation of the filter element 10 from FIG. 1, focusing on the centering element 20. Visible in the interior of filter element 10 is a support tube 38 that reinforces the first filter body 12. Also easily visible is the reinforcement of the centering element 20 by the supports 36, which connect both walls 32, 34 of the centering element 20 formed from the two tube segments 28, 30. The second flow outlet 26 between the two walls 32, 34 is also visible. The second flow outlet 26 has two diametrically opposing restrictions 64 in the form of apertures in the end disc 16 transitioning into the centering element 20. The volume flow that flows via the second filter body 14 may be adjusted using the dimensions of the restrictions 64.

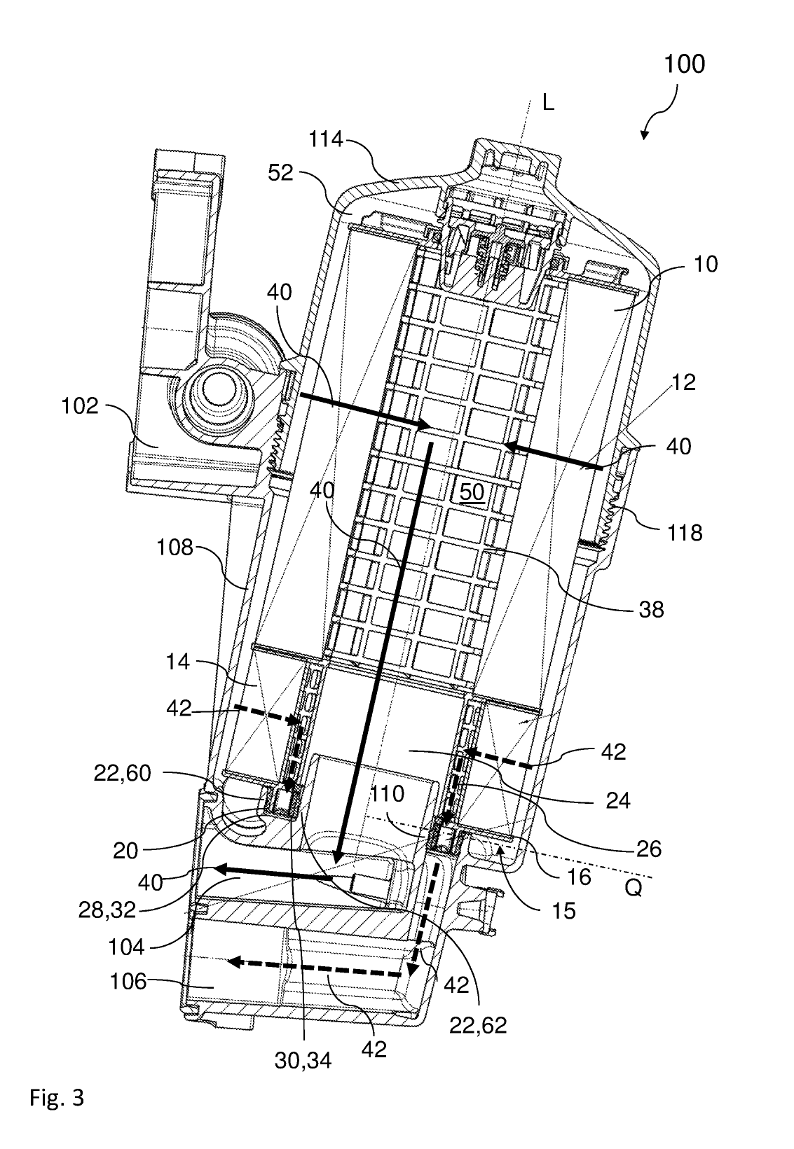

FIG. 3 is a longitudinal section of a filter system 100 in accordance with one exemplary embodiment of the invention. The filter system 100 includes a filter housing 108, an inlet 102 arranged on the filter housing 108 for supplying a fluid to be filtered, especially oil, first and second outlets 104, 106 arranged on the filter housing 108 for draining the filtered fluid, and at least one exchangeable filter element 10 that is arranged between the inlet 102 and the two outlets 104, 106 and separates a raw side 52 of the filter system from a clean side 50 of the filter system. The filter housing 108 is closed with a cover 114 using a thread 118 so that the housing is easy to open when exchanging a filter element. The filter element 10 includes a first filter body 12 that is separated in a fluid-tight fashion from a second filter body 14 and that is arranged above the second filter body 14 in an axial direction L and is securely connected thereto. A first flow outlet 24 proceeds from the first filter body 12 and opens into a first outlet 104. A second flow outlet 26 proceeding from the second filter body 14 is arranged outside the first flow outlet 24 in a transverse direction Q perpendicular to the axial direction L and opens into the second outlet 106. A centering element 20 that acts in the transverse direction is arranged on an end disc 16 of an end face 15 of the filter element 10 and corresponds to a corresponding receptacle 110 of a filter housing 108. Also in FIG. 3 is the flow direction 40 that is for the main flow filter operation and leads from the raw side 52 through the first filter body 12 and the support tube 38 to the clean side 50 into the interior of the first filter body 12. Then the flow direction 40 leads through the first flow outlet 24 into the outlet 104 of the filter system. In contrast, the flow direction 42 for the partial flow filter operation also leads from the raw side 52 through the second filter body 14 and on the interior of the filter body 14 through the second flow outlet 26 into the second outlet 106. In the radially symmetrical arrangement, in which the transverse direction Q is a direction radially perpendicular to the axial direction L, the second flow outlet 26 surrounds the first flow outlet 24 in the form of a hollow cylinder and opens into the annular centering element 20. When exchanging the filter element 10, the cover 114 of the filter system 100 is screwed off using the thread 118, the cover 114 is removed, and the filter element 10 is removed upwardly in the axial direction L. The centering element 20 with the second flow outlet 26 initially remains engaged in the receptacle 110, so that the fluid remaining in the filter element 10 can flow back through the second flow outlet 26 into the second outlet 106 and thus for instance into the oil sump.

In the embodiment illustrated, the filter system 100 may be used as an oil filter, especially as an oil filter for an internal combustion engine.

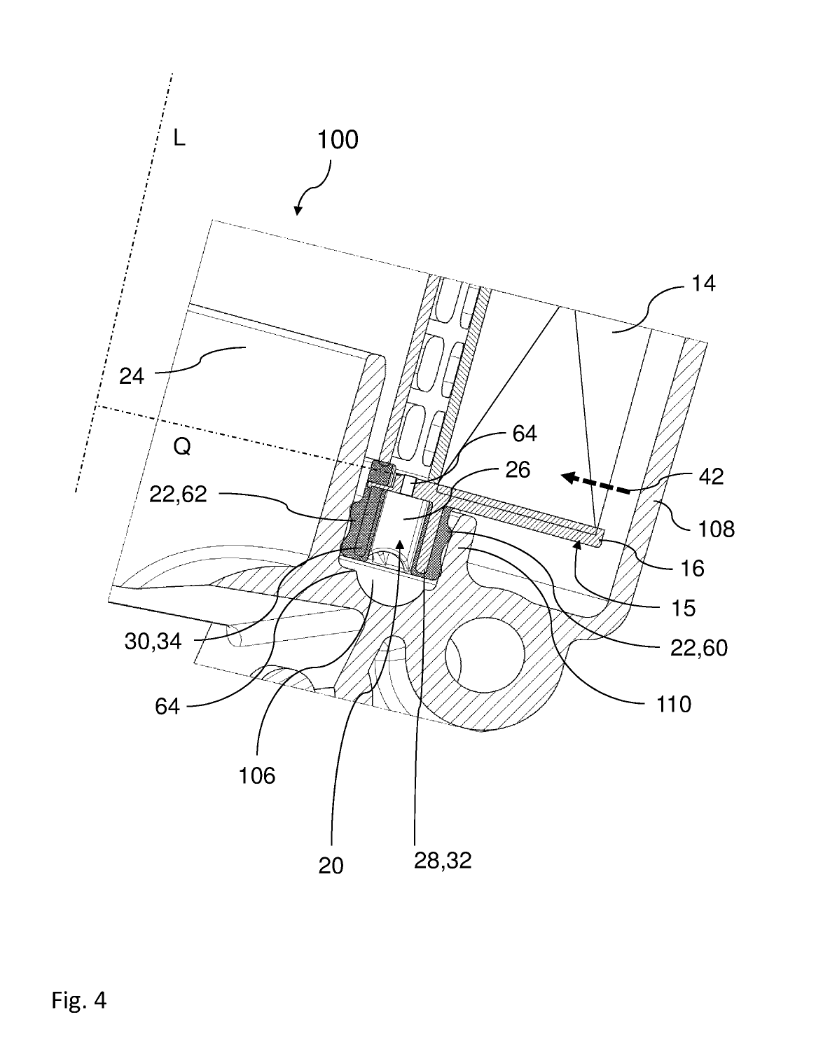

FIG. 4 is a detail of the longitudinal section in FIG. 3, focusing on the centering element 20. In this figure, the details of the centering element 20 may be seen with the two walls 32, 34 of the two tube segments 28, 30 from which the centering element 20 is formed and which surround the second flow outlet 26. Arranged on the inside, in the radial direction Q, of the wall 34 is a seal 62 of the double concentric sealing element 22, while arranged on the outside, in the radial direction Q, of the wall 32 is a seal 60 of the double concentric sealing element 22. Added to the free cross-section of the second flow outlet 26 is a restriction 64 that restricts the flow of the fluid filtered through the second filter body 14 in the partial flow filter operation in a suitable manner. Alternatively, the second flow outlet 26 may itself form or have a restriction 64.

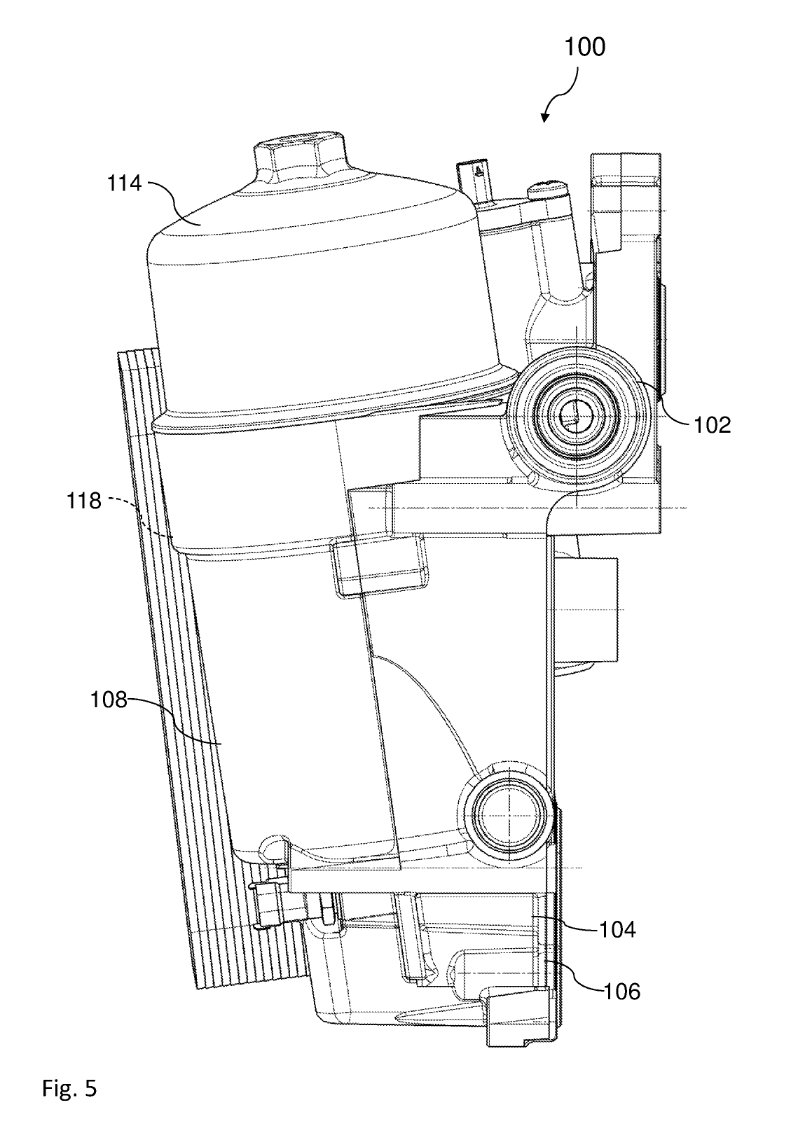

FIG. 5 is an exterior view of a filter system 100 in accordance with one exemplary embodiment of the invention. The filter housing 108 is closed with a cover 114 using the thread 118, which, because it is disposed in the interior, is not visible in FIG. 5. Using this it is possible to open the filter housing 108, for instance for exchanging the filter element 10. Also depicted are the inlet 102 for supplying the fluid to be filtered and the two outlets 104, 106 for the draining of the filtered fluid from the main flow filter and the partial flow filter.

What is claimed is:

1. A filter element, comprising:
a first filter body;
a second filter body separated in a fluid-tight fashion from the first filter body;
wherein the first filter body is arranged axially above the second filter body in an axial direction (L) and is securely connected to the second filter body via an end disk of the first filter body;
a first flow outlet proceeds axially from the first filter body through an open central portion of the second filter body;
a second flow outlet proceeding axially from the second filter body and arranged radially outwards from the first flow outlet;
wherein a centering element that acts in a direction traverse to the axial direction is arranged on an end disc of an end face of the filter element and is arranged and positioned to engage with a corresponding receptacle of a filter housing when in an installed state.

2. The filter element in accordance with claim 1, wherein
the second flow outlet is arranged inside of the centering element.

3. The filter element in accordance with claim 1, wherein
the transverse direction is a direction radially perpendicular to the axial direction.

4. The filter element in accordance with claim 1, wherein
the centering element is formed by two tube segments nested inside one another.

5. The filter element in accordance with claim 4, wherein
walls of the two tube segments are connected to one another via supports.

6. The filter element in accordance with claim 1, wherein
the centering element comprises
a radially double-concentric sealing element configured to seal to the filter housing when in an installed state.

7. The filter element in accordance with claim 6, wherein
the double concentric sealing element is formed directly onto an end disc of the second filter body;
wherein double concentric sealing element is molded directly on the end disc of the second filter body.

8. The filter element in accordance with claim 6, wherein
the double-concentric sealing element comprises
at least one seal; and
a second seal arranged radially inwardly from the at least one seal.

9. The filter element in accordance with claim 1, wherein
at least one restriction is arranged in the second flow outlet of the filter element.

10. The filter element in accordance with claim 9, wherein
the at least one restriction is formed by at least one restriction aperture extending through tend disc of the second filter body.

11. The filter element in accordance with claim 1, wherein
the second flow outlet forms or has at least one restriction.

12. A filter system, comprising:
a filter housing, including:
an inlet arranged on the filter housing for supplying a fluid to be filtered;
a first outlet arranged on the housing for draining the filtered fluid;
a second outlet arranged on the housing for draining the filtered fluid;
at least one exchangeable filter element that is arranged between the inlet and the first and the second outlets and separates a raw side of the filter system from a clean side of the filter system;
wherein the at least one exchangeable filter element includes:
a first filter body;
a second filter body separated in a fluid-tight fashion from the first filter body;
wherein the first filter body is arranged axially above the second filter body in an axial direction (L) and is securely connected to the second filter body via an end disk of the first filter body;
a first flow outlet proceeds axially from the first filter body through an open central portion of the second filter body and is connected to flow into the first outlet of the filter housing;
a second flow outlet, proceeding axially from the second filter body is arraged radially outwards from the first flow outlet and is connected to flow into the second outlet of the filter housing;
wherein a centering element that acts in a direction traverse to the axial direction is arranged on an end disc of an end face of the filter element and engages with a corresponding receptacle of the filter housing.

13. The filter system in accordance with claim 12, wherein
the transverse direction is a direction radially perpendicular to the axial direction (L).

14. The filter system in accordance with claim 12, wherein
the second filter body is embodied as a partial flow filter.

15. The filter system in accordance with claim 12, wherein
the filter system is configured as an oil filter to filter oil filter for an internal combustion engine.
